(19) United States
(12) Patent Application Publication
(10) Pub. No.: US 2015/0022403 A1
(43) Pub. Date: Jan. 22, 2015

(54) MOBILE DEVICE AND ANTENNA STRUCTURE THEREIN

(71) Applicant: Acer Incorpporated, New Taipei City (TW)

(72) Inventor: Ching-Chi Lin, New Taipei City (TW)

(73) Assignee: Acer Incorporated, New Taipei City (TW)

(21) Appl. No.: 14/254,207

(22) Filed: Apr. 16, 2014

(30) Foreign Application Priority Data
Jul. 22, 2013 (TW) 102126053

(51) Int. Cl. H01Q 1/24

(52) U.S. Cl. CPC H01Q 1/241
USPC 343/702

(57) ABSTRACT

A mobile device includes a proximity sensor, a controller, an RF (Radio Frequency) module, and a metal frame. The proximity sensor generates a detection signal. The controller generates a control signal according to the detection signal. The RF module generates an RF feeding signal, and adjusts an RF power of the RF feeding signal according to the control signal. The metal frame includes a first portion and a second portion. An antenna structure is formed by the first portion. A sensing metal element is formed by the first portion and the second portion. The sensing metal element is further coupled to the proximity sensor. The antenna structure directly or indirectly receives the RF feeding signal from the RF module.

### CROSS REFERENCE TO RELATED APPLICATIONS

This application claims priority of Taiwan Patent Application No. 102126053 filed on Jul. 22, 2013, the entirety of which is incorporated by reference herein.

### BACKGROUND OF THE INVENTION

1. Field of the Invention

The disclosure generally relates to a mobile device, and more particularly to a mobile device including a metal frame, which is used as both an antenna structure and a sensing metal element of a proximity sensor (P-sensor).

2. Description of the Related Art

With the progress of mobile communication technology, portable electronic devices, for example, portable computers, mobile phones, tablet computers, multimedia players, and other hybrid functional mobile devices, have become more common To satisfy user demand, portable electronic devices can usually perform wireless communication functions. Some functions cover a large wireless communication area, for example, mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some functions cover a small wireless communication area, for example, mobile phones using Wi-Fi, Bluetooth, and WiMAX (Worldwide Interoperability for Microwave Access) systems and using frequency bands of 2.4 GHz, 3.5 GHz, 5.2 GHz, and 5.8 GHz.

An antenna element is a key component for a mobile device with a wireless communication function. To meet the criterion of SAR (Specific Absorption Rate) set by the government, an antenna designer often incorporates a proximity sensor (P-sensor) into a mobile device. However, there is limited space in a mobile device, and it cannot accommodate both an antenna element and a sensing metal board of a proximity sensor.

### BRIEF SUMMARY OF THE INVENTION

To improve the problem of the prior art, in one exemplary embodiment, the disclosure is directed to a mobile device, including: a proximity sensor, generating a detection signal; a controller, generating a control signal according to the detection signal; an RF (Radio Frequency) module, generating an RF feeding signal, and adjusting an RF power of the RF feeding signal according to the control signal; and a metal frame, including a first portion and a second portion, in which, an antenna structure is formed by the first portion, a sensing metal element is formed by the first portion and the second portion, the sensing metal element is coupled to the proximity sensor, and the antenna structure directly or indirectly receives the RF feeding signal from the RF module.

### BRIEF DESCRIPTION OF DRAWINGS

The invention can be more fully understood by reading the subsequent detailed description and examples with references made to the accompanying drawings, wherein:

FIG. 1 is a diagram for illustrating a mobile device according to an embodiment of the invention;

FIG. 2 is a diagram for illustrating a mobile device according to a preferred embodiment of the invention;

FIG. 3A is a diagram for illustrating antenna efficiency of an antenna structure of a mobile device when the antenna structure operates in a low band according to an embodiment of the invention; and

FIG. 3B is a diagram for illustrating antenna efficiency of an antenna structure of a mobile device when the antenna structure operates in a high band according to an embodiment of the invention.

### DETAILED DESCRIPTION OF THE INVENTION

In order to illustrate the purposes, features and advantages of the invention, the embodiments and figures of the invention are shown in detail as follows.

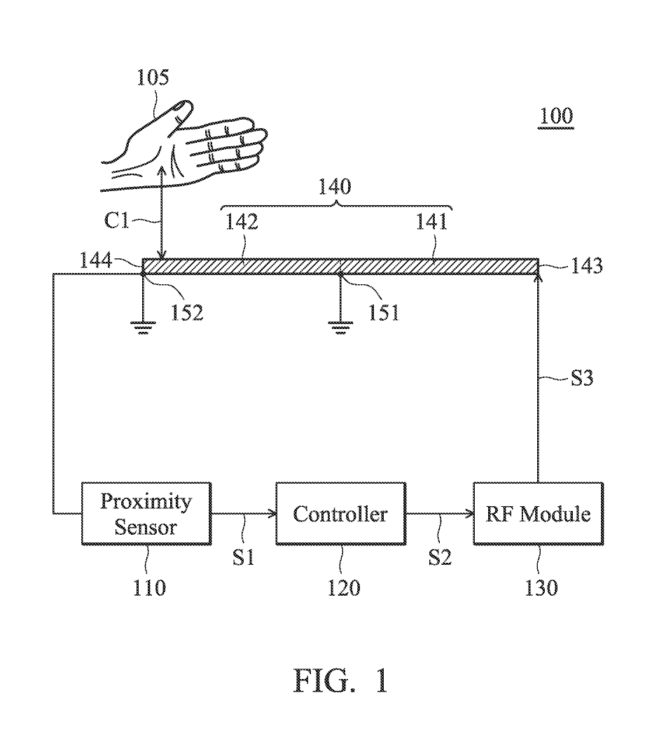

FIG. 1 is a diagram for illustrating a mobile device 100 according to an embodiment of the invention. The mobile device 100 may be a smartphone, a tablet computer, or a notebook computer. As shown in FIG. 1, the mobile device 100 at least includes a proximity sensor (P-sensor) 110, a controller 120, an RF (Radio Frequency) module 130, and a metal frame 140. Note that the mobile device 100 may further include other components, such as a processor, a touch panel, a touch control module, a system circuit board, a speaker, a battery module, and a housing (not shown).

The metal frame 140 may be disposed on a nonconductive housing (not shown) of the mobile device 100. For example, the nonconductive housing may include a back cover made of carbon fibers. The metal frame 140 includes a first portion 141 and a second portion 142, and the first portion 141 and the second portion 142 are coupled to each other. In some embodiments, the metal frame 140 substantially has a straight-line shape or an inverted U-shape to be attached to an edge of the nonconductive housing. An antenna structure is formed by the first portion 141 of the metal frame 140, and a sensing metal element is formed by the first portion 141 and the second portion 142 of the metal frame 140. The RF module 130 is configured as a signal source of the antenna structure, and the antenna structure directly or indirectly receives an RF feeding signal S3 from the RF module 130. The sensing metal element is coupled to the proximity sensor 110. The proximity sensor 110 uses the sensing metal element to detect whether a conductor approaches itself and accordingly generates a detection signal S1. In some embodiments, when a conductor (or a part of a human body, e.g., a palm) 105 is disposed adjacent to the mobile device 100, an equivalent capacitor C1 is formed between the conductor 105 and the sensing metal element, and the proximity sensor 110 detects a capacitance of the equivalent capacitor C1 and accordingly generates the detection signal S1. The controller 120 generates a control signal S2 according to the detection signal S1. In some embodiments, the controller 120 is an EC (Embedded Controller) for controlling a variety of electronic components in the mobile device 100. The RF module 130 generates the RF feeding signal S3, and adjusts an RF power of the RF feeding signal S3 according to the control signal S2 to meet the criterion of SAR (Specific Absorption Rate). For example, when the conductor 105 is disposed adjacent to the mobile device 100, the capacitance of the equivalent capacitor C1 is increased, and the RF module 130 decreases the RF power of the RF feeding signal S3 to decrease the SAR of the mobile device 100. Conversely, when the conductor 105 is disposed away from the mobile device 100, the capacitance of the equivalent capacitor C1 is decreased, and the RF module 130 increases the RF power of the RF feeding signal S3 to maintain good communication quality of the mobile device 100.

In some embodiments, the metal frame 140 has a first grounding point 151 and a second grounding point 152, and the first grounding point 151 is separate from the second grounding point 152. The proximity sensor 110 may be coupled to the second grounding point 152. The metal frame 140 has a first end 143 and a second end 144, and the first end 143 is opposite to the second end 144. The first end 143 of the metal frame 140 is arranged to directly or indirectly receive the RF feeding signal S3. In some embodiments, the first end 143 of the metal frame 140 is directly coupled to the RF module 130 such that the antenna structure is excited. In some embodiments, the first grounding point 151 is positioned between the first portion 141 and the second portion 142 of the metal frame 140, and the second grounding point 152 is positioned at the second end 144 of the metal frame 140. In other words, the first portion 141 of the metal frame 140 is positioned between the first end 143 of the metal frame 140 and the first grounding point 151, and the second portion 142 of the metal frame 140 is positioned between the second end 144 of the metal frame 140 and the first grounding point 151.

In the invention, the metal frame 140 of the mobile device 100 is configured as both an antenna structure and a sensing metal element of the proximity sensor 110. The inner space of the mobile device 100 is effectively used by integrating the two essential components. As to the antenna theory, one end of the first portion 141 of the metal frame 140 is arranged to receive the RF feeding signal S3, and the other end of the first portion 141 of the metal frame 140 is coupled to the first grounding point 151. Therefore, the antenna structure of the mobile device 100 is considered as a loop antenna. The loop antenna has a relatively closed structure, and its radiation performance is not affected so much by nearby electronic components. On the other hand, the second portion 142 of the metal frame 140 is coupled between the first grounding point 151 and the second grounding point 152, and it is mainly configured as a portion of the sensing metal element, rather than the antenna structure. Since the proximity sensor 110 is coupled to the second grounding point 152 of the metal frame 140 and away from a feeding end of the antenna structure (i.e., the first end 143 of the metal frame 140), the proximity sensor 110 does not tend to negatively affect the radiation performance of the antenna structure. As a result, the invention has the advantages of both maintaining good communication quality and minimizing the total size of the mobile device, and therefore it is suitable for being applied to a variety of thin mobile communication products.

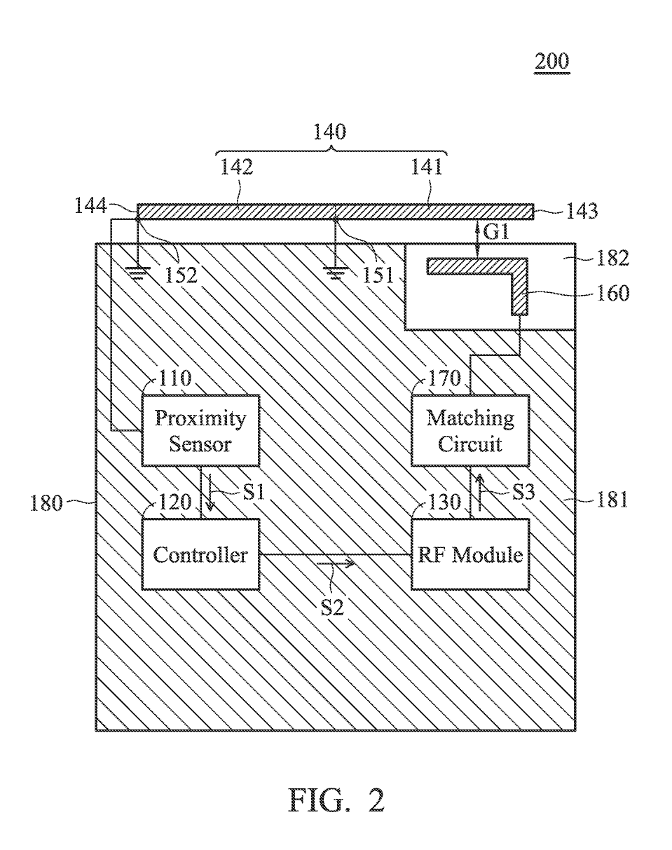

FIG. 2 is a diagram for illustrating a mobile device 200 according to a preferred embodiment of the invention. FIG. 2 is similar to FIG. 1. In the embodiment of FIG. 2, the mobile device 200 may further include one or more of the following components: a feeding metal element 160, a matching circuit 170, and a system circuit board 180. In some embodiments, an antenna structure of the mobile device 200 includes the first portion 141 of the metal frame 140 and the feeding metal element 160, and the feeding metal element 160 is separate from the metal frame 140. The feeding metal element 160 is coupled to the RF module 130, and is disposed adjacent to the first end 143 of the metal frame 140 so as to excite the antenna structure by mutual coupling. As to the antenna theory, a quarter-wavelength (λ/4) monopole antenna is formed by the feeding metal element 160 to generate a high band, and a half-wavelength (λ/2) coupled-fed loop antenna is formed by the feeding metal element 160 and the first portion 141 of the metal frame 140 to generate a low band. In some embodiments, the feeding metal element 160 substantially has an L-shape. In other embodiments, the feeding metal element 160 may have other shapes, such as a straight-line shape, an inverted U-shape, an S-shape, or a W-shape. In some embodiments, a width of a coupling gap G1 formed between the feeding metal element 160 and the metal frame 140 is smaller than 2 mm. The matching circuit 170 may be coupled between the RF module 130 and the feeding metal element 160, and may be configured to adjust the impedance matching of the antenna structure. In some embodiments, the matching circuit 170 includes one or more capacitors and/or inductors, such as at least one capacitor and at least one inductor that are coupled in series or in parallel. The system circuit board 180 may be an FR4 (Flame Retardant 4) substrate. The system circuit board 180 includes a ground plane 181 and carries a variety of electronic components, such as the proximity sensor 110, the controller 120, the RF module 130, the feeding metal element 160, and the matching circuit 170. The metal frame 140 is independent of the system circuit board 180. The first grounding point 151 and the second grounding point 152 of the metal frame 140 are coupled to the ground plane 181. In some embodiments, the first grounding point 151 and/or the second grounding point 152 are coupled through a screw, a pogo pin, or a metal spring to the ground plane 181 (not shown). The system circuit board 180 may further have a non-grounding region 182. The feeding metal element 160 may be implemented with a metal trace disposed on the non-grounding region 182. In some embodiments, the non-grounding region 182 substantially has a rectangular shape formed at a corner of the system circuit board 180. Other features of the mobile device 200 of FIG. 2 are similar to those of the mobile device 100 of FIG. 1. Accordingly, the two embodiments can achieve similar performances.

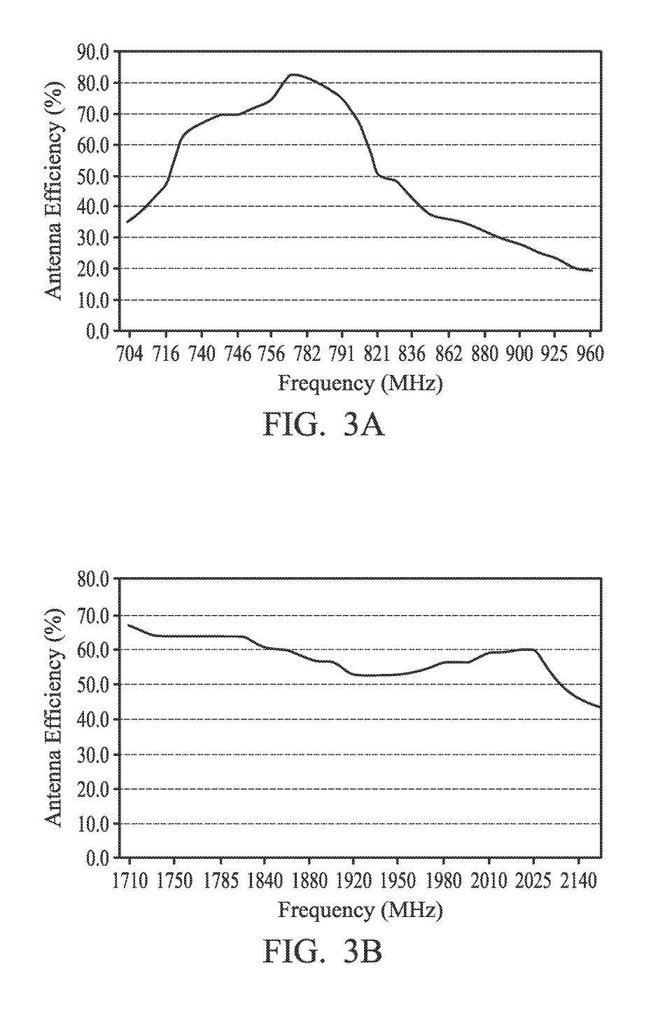

FIG. 3A is a diagram for illustrating the antenna efficiency of the antenna structure of the mobile device 100 (or 200) when the antenna structure operates in a low band according to an embodiment of the invention. FIG. 3B is a diagram for illustrating the antenna efficiency of the antenna structure of the mobile device 100 (or 200) when the antenna structure operates in a high band according to an embodiment of the invention. Please refer to FIGS. 3A and 3B together, in which the horizontal axis represents operation frequency (MHz), and the vertical axis represents the antenna efficiency (%). In a preferred embodiment, the antenna structure of the mobile device 100 (or 200) is excited to generate a first band and a second band, in which the first band is substantially from 704 MHz to 960 MHz, and the second band is substantially from 1710 MHz to 2170 MHz. Therefore, the mobile device 100 (or 200) of the invention can at least operate in multiple bands of LTE (Long Term Evolution) Band 17, LTE Band 13, WCDMA (Wideband Code Division Multiple Access) Band 8, DCS (Distributed Control System), PCS (Personal Communications Service), WCDMA Band 1, and LTE Band 4. As shown in FIG. 3A and FIG. 3B, the antenna efficiency of the antenna structure of the mobile device 100 (or 200) may be about 40% or more in the first band (low band), and may be from about 40% to 70% in the second band (high band). The aforementioned antenna efficiency can meet the requirements of practical applications.

Note that the aforementioned element parameters, element shapes, and frequency ranges are not limitations of the invention. An antenna engineer can adjust these settings according to different requirements.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A mobile device, comprising:
a proximity sensor, generating a detection signal;
a controller, generating a control signal according to the detection signal;
an RF (Radio Frequency) module, generating an RF feeding signal, and adjusting an RF power of the RF feeding signal according to the control signal; and
a metal frame, comprising a first portion and a second portion, wherein an antenna structure is formed by the first portion, a sensing metal element is formed by the first portion and the second portion, and the sensing metal element is coupled to the proximity sensor;
wherein the antenna structure directly or indirectly receives the RF feeding signal from the RF module.

2. The mobile device as claimed in claim 1, wherein when a conductor is disposed adjacent to the mobile device, an equivalent capacitor is formed between the conductor and the sensing metal element, and the proximity sensor detects a capacitance of the equivalent capacitor and accordingly generates the detection signal.

3. The mobile device as claimed in claim 1, wherein the metal frame has a first grounding point and a second grounding point, and the first grounding point is separate from the second grounding point.

4. The mobile device as claimed in claim 3, wherein the metal frame has a first end and a second end, the first end is opposite to the second end, the first end is arranged to receive the RF feeding signal, the first grounding point is positioned between the first portion and the second portion of the metal frame, and the second grounding point is positioned at the second end.

5. The mobile device as claimed in claim 3, wherein the proximity sensor is coupled to the second grounding point.

6. The mobile device as claimed in claim 4, wherein the first end of the metal frame is directly coupled to the RF module.

7. The mobile device as claimed in claim 4, further comprising:
a feeding metal element, coupled to the RF module, and disposed adjacent to the first end of the metal frame, wherein the feeding metal element is separate from the metal frame.

8. The mobile device as claimed in claim 7, wherein the feeding metal element substantially has an L-shape.

9. The mobile device as claimed in claim 7, wherein a width of a coupling gap formed between the feeding metal element and the metal frame is smaller than 2 mm.

10. The mobile device as claimed in claim 7, further comprising:
a matching circuit, coupled between the RF module and the feeding metal element, and adjusting impedance matching of the antenna structure.

11. The mobile device as claimed in claim 7, further comprising:
a system circuit board, comprising a ground plane, wherein the first grounding point and the second grounding point of the metal frame are coupled to the ground plane.

12. The mobile device as claimed in claim 11, wherein the system circuit board further has a non-grounding region, and the feeding metal element is implemented with a metal trace disposed on the non-grounding region.

13. The mobile device as claimed in claim 1, wherein the metal frame is disposed on a nonconductive housing of the mobile device.

14. The mobile device as claimed in claim 1, wherein the antenna structure is excited to generate a first band and a second band, the first band is substantially from 704 MHz to 960 MHz, and the second band is substantially from 1710 MHz to 2170 MHz.
